(19) United States
(12) Patent Application Publication
(10) Pub. No.: US 2026/0023366 A1
(43) Pub. Date: Jan. 22, 2026

(54) MANAGING ANCHORS IN AN INDUSTRIAL AUGMENTED REALITY SYSTEM

(71) Applicant: International Business Machines Corporation, Armonk, NY (US)

(72) Inventors: Charan Acharya Chandrashekar, Bangalore (IN); Satyam Jakkula, BENGALURU (IN); Ankit Dwivedi, Bangalore (IN)

(21) Appl. No.: 18/773,678

(22) Filed: Jul. 16, 2024

(51) Int. Cl. G05B 19/4155

(52) U.S. Cl. CPC G05B 19/4155; G05B 2219/32014

(57) ABSTRACT

Computer-implemented methods for managing anchors in an industrial augmented reality system are provided. Aspects include receiving, from a machine in an industrial environment, an identifier of the machine, an identification of anchors associated with the machine, a position of the machine in the industrial environment, and an orientation of the machine and creating, by the industrial augmented reality system, a augmented reality framework for the industrial environment. Aspects also include receiving, by the industrial augmented reality system from the machine, an indication that one or more of the position of the machine in the industrial environment and the orientation of the machine has changed and updating, the augmented reality framework for the industrial environment based on the indicated change to of the one or more of the position of the machine in the industrial environment and the orientation of the machine.

### BACKGROUND

The present disclosure generally relates to managing an industrial augmented reality system, and more specifically, to methods and systems for managing anchors in an industrial augmented reality system.

In general, an industrial environment can include a plurality of pieces of complex machinery that are operated by workers. Recently, the use of augmented reality (AR) by workers in the industrial environment has been adopted to assist the workers with the operation of complex machinery. In general, AR is a technology that superimposes digital content such as images, sounds, and videos onto the real world, enabling users to interact with both the physical and virtual environment.

In general, when a worker uses an AR device in an industrial environment, anchors, or digital markers, are overlayed in the AR display of the physical world. The anchors indicate the presence of content that corresponds to a portion of a piece of machinery that is indicated by the location of the anchor. The anchors serve as reference points that allow virtual objects to be placed, aligned, or interact with the real environment in a coherent manner. Anchors help maintain the stability and position of digital elements within the AR experience, ensuring they remain fixed relative to the physical world as the user moves around.

Currently, the locations of anchors in an industrial augmented reality system are manually entered and maintained by an administrator of the industrial augmented reality system. As a result, the locations of the anchors in the industrial augmented reality system must both be manually entered into the industrial augmented reality system and manually updated each time a piece of machinery is added to the industrial environment, removed from the industrial environment, or moved within the industrial environment.

### SUMMARY

Embodiments of the present disclosure are directed to computer-implemented methods for managing anchors in an industrial augmented reality system. According to an aspect, a computer-implemented method includes receiving, from a machine in an industrial environment, an identifier of the machine, an identification of one or more anchors associated with the machine, a position of the machine in the industrial environment, and an orientation of the machine. The method also includes creating, by the industrial augmented reality system, a augmented reality framework for the industrial environment, wherein the augmented reality framework includes a location of the one or more anchors associated with the machine in the industrial environment. The method further includes receiving, by the industrial augmented reality system from the machine, an indication that one or more of the position of the machine in the industrial environment and the orientation of the machine has changed and updating, the augmented reality framework for the industrial environment based on the indicated change to of the one or more of the position of the machine in the industrial environment and the orientation of the machine.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a system for managing anchors in an industrial augmented reality system in accordance with one or more embodiments of the present disclosure;

FIG. 3 depicts a block diagram of an augmented reality device in accordance with one or more embodiments of the present disclosure;

FIG. 4 depicts a block diagram of a piece of machinery in accordance with one or more embodiments of the present disclosure;

FIG. 5 depicts a flowchart of a method for managing anchors in an industrial augmented reality system in accordance with one or more embodiments of the present disclosure; and

FIG. 6 depicts a flowchart of a method for managing anchors in an industrial augmented reality system in accordance with one or more embodiments of the present disclosure.

### DETAILED DESCRIPTION

As discussed above, the locations of anchors in an industrial augmented reality system are currently manually entered and maintained by an administrator of the industrial augmented reality system. As a result, the locations of the anchors in the industrial augmented reality system must both be manually entered into the industrial augmented reality system and manually updated each time a piece of machinery is added to the industrial environment, removed from the industrial environment, or moved within the industrial environment. In an industrial environment that includes a large number of pieces of machinery, the time and cost of both creating the anchors and maintaining the proper location of the anchors as the locations and/or orientation of the pieces of machinery are moved is very high.

Exemplary embodiments include methods, systems, and computer program products for managing anchors in an industrial augmented reality system. In exemplary embodiments, the machinery in an industrial environment includes a plurality of sensors, a memory, and a processor that are configured to detect the location and orientation of machinery. In addition, the memory of the machinery includes a record of each anchor that corresponds to the machinery and is configured to determine a location in the industrial environment where each of its anchors should be displayed. Further, the machinery includes a communications system that is configured to transmit the location of the machinery, the orientation of the machinery, and the location of each of the anchors of the machinery to an industrial augmented reality system. In exemplary embodiments, the industrial augmented reality system receives the location, orientation, and anchor data from a plurality of pieces of machinery in the industrial environment and stores the data in a virtual content database, which is utilized by an augmented reality rendering engine of the industrial augmented reality system to create an augmented reality framework of the industrial environment. In exemplary embodiments, the machinery in the industrial environment is configured to detect a change in its position and/or orientation and to communicate the detected change to the industrial augmented reality system, which automatically updates the framework of the augmented reality framework of the industrial environment.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as managing anchors in an industrial augmented reality system, as shown at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

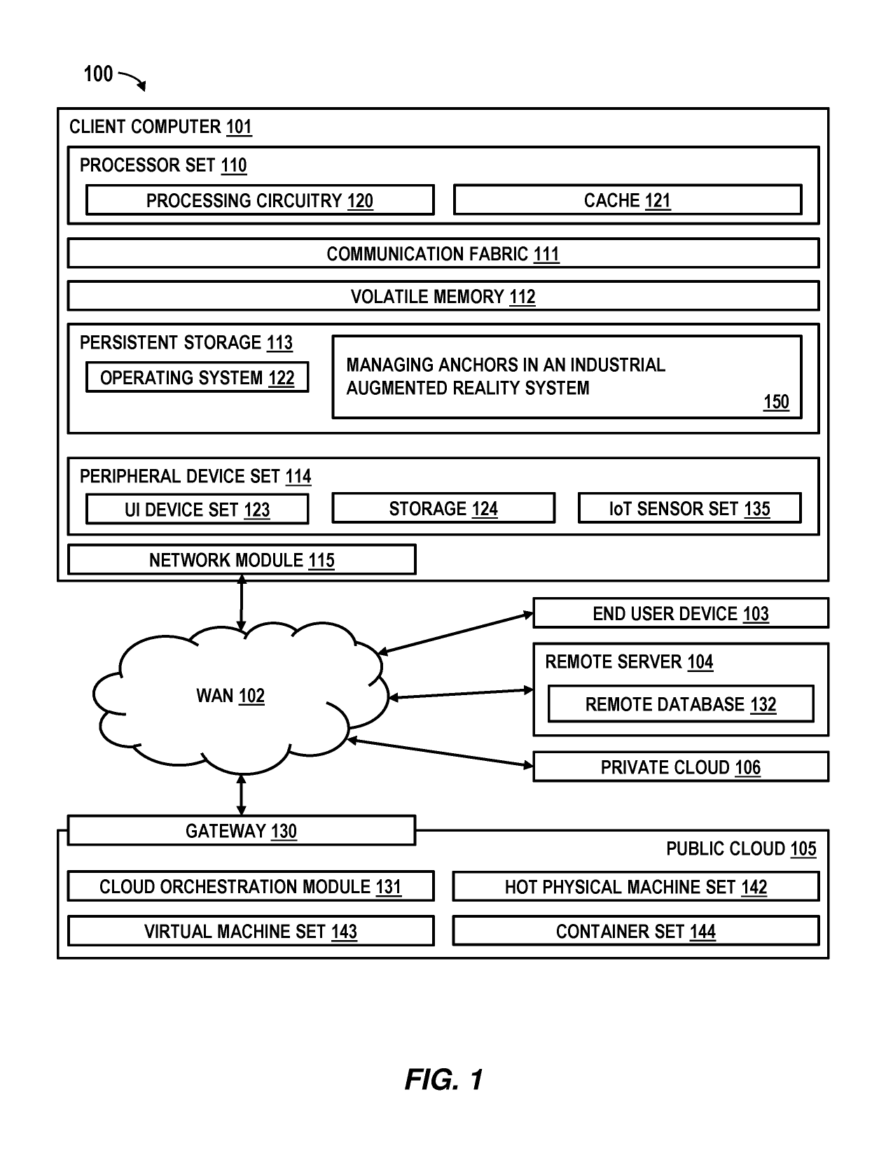

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

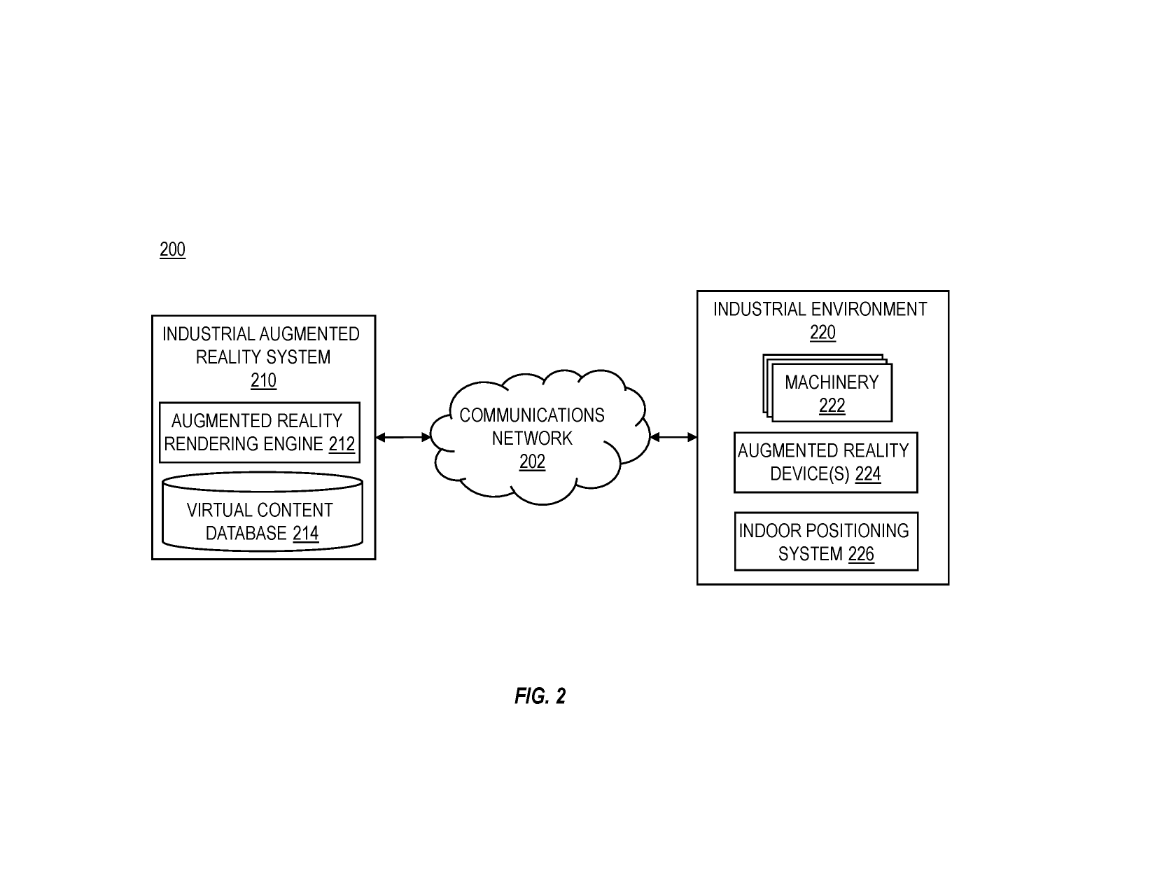

Referring now to FIG. 2, a block diagram of a system 200 for managing anchors in an industrial augmented reality system in accordance with one or more embodiments of the present disclosure is shown. As illustrated, the system 200 includes an industrial augmented reality system 210 and an industrial environment 220 having a plurality of pieces of machinery 222 and an augmented reality device 224 that are in communication with the industrial augmented reality system 210 via a communications network 202. The communications network 202 may include a private network, a public network such as the Internet, or a combination thereof. In exemplary embodiments, the industrial augmented reality system 210 may be embodied in a computing environment 100 as shown in FIG. 1.

In exemplary embodiments, the industrial environment 220 includes a plurality of pieces of machinery 222 that are disposed at various locations within the industrial environment 220. In exemplary embodiments, one or more workers in the industrial environment 220 utilize augmented reality (AR) devices 224 to view the industrial environment 220. The augmented reality devices 224 are display devices that blend digital information with the industrial environment 220, enhancing the worker's perception and interaction with the industrial environment 220. In exemplary embodiments, the augmented reality device 224 may be embodied in glasses or a headset that is worn by a worker. The AR devices 224 use advanced sensors, cameras, and display technologies to overlay computer-generated graphics, information, or interactive elements onto the industrial environment 220. The augmented reality device 224 provides an immersive and enriched experience, allowing the workers to access contextual information, navigate spaces, visualize data, and engage in interactive applications, all while maintaining a connection to the industrial environment 220.

In exemplary embodiments, the industrial environment 220 also includes an indoor positioning system 226 that is utilized by both the machinery 222 and the augmented reality devices 224 to determine their location and orientation within the industrial environment 220. The indoor positioning system 226 may be one of a Wi-Fi-based indoor positioning system, a Bluetooth low energy indoor positioning system, an ultra-wideband indoor positioning system, an infrared-based indoor positioning system, a radio frequency identification indoor positioning system, or the like. In an exemplary embodiment, the machinery 222 is configured to determine its location and orientation within the industrial environment 220 using the indoor positioning system 226 and to transmit its location and orientation data to the industrial augmented reality system 210 via the communications network 202. In exemplary embodiments, the communications network 202, or another communication system may be used by the augmented reality devices 224 to communicate with the machinery 222.

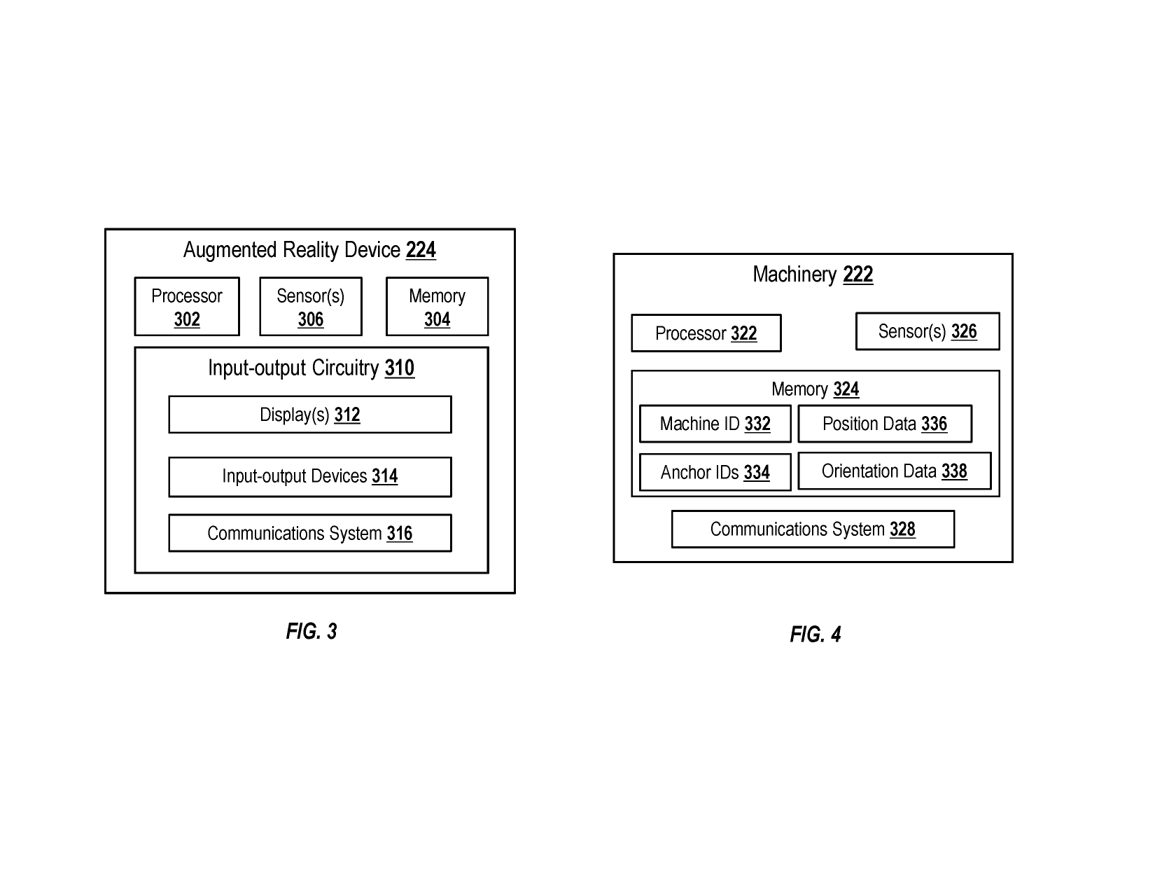

Referring now to FIG. 3, a block diagram of an augmented reality (AR) device 224 in accordance with one or more embodiments of the present disclosure is shown. As illustrated, the augmented reality device 224 includes a processor 302, a memory 304, sensors 306, and input-output circuity 310. In exemplary embodiments, the AR device 224 is embodied in glasses or a headset that are worn by a worker. In exemplary embodiment, the processor 302 is configured to utilize data received by the sensors 306 from the indoor positioning system (shown in FIG. 2) to determine the location and orientation of the AR device 224 within the industrial environment 220. The input-output circuity 310 includes a display 312, one or more input-output devices 314, and a communication system 316. The display 312 is configured to overlay computer-generated graphics, information, or interactive elements onto the industrial environment 220. In exemplary embodiments, one or more input-output devices 314 are configured to detect the interaction between a user of the AR device with the displayed computer-generated graphics, information, or interactive elements. For example, the input-output devices 314 may include a camera, touch screen device, or the like. In exemplary embodiments, the communications system 316 is configured to communicate with one or more of the industrial augmented reality system 210 and the machinery 222. For example, the communications system 316 may be configured to obtain an augmented reality framework of the industrial environment 220 from the industrial augmented reality system 210. The memory 304 may be used to store a copy of the augmented reality framework of the industrial environment 220 from the industrial augmented reality system 210.

Referring now to FIG. 4, a block diagram of a piece of machinery 222 in accordance with one or more embodiments of the present disclosure is shown. As illustrated, the machinery 222 includes a processor 322, a memory 324, one or more sensors 326, and a communications system 328. In exemplary embodiments, the processor 322 is configured to utilize data received by one or more of the sensors 326 from the indoor positioning system (shown in FIG. 2) to determine the location and orientation of the machinery 222 within the industrial environment 220. In exemplary embodiments, the location and orientation of the machinery 222 are stored as positional data 336 and orientation data 338 in the memory 324. In exemplary embodiments, the memory 324 also includes a machine identification 332 that stores a unique identifier of the machinery 222 and one or more anchor identifiers 334 that stores a unique identifier of each anchor that corresponds to the machinery 222. In one embodiment, the one or more anchor identifiers 334 also include relative position information that defines the position of the anchor 334 relative to the position and the orientation of the machinery 222. In exemplary embodiments, the communications system 328 is configured to transmit the contents of the memory 324 to the industrial augmented reality system 210 shown in FIG. 2.

In exemplary embodiments, the machinery 222 includes one or more operational parameters, such as an operational speed, a temperature, and an operation direction, which are monitored by one or more sensors 326. In exemplary embodiments, the operational parameters obtained from these sensors 326 may be provided to the industrial augmented reality system 210 via the communications network 202 or directly to one or more augmented reality devices 224 within a predetermined range of the machinery 222. In exemplary embodiments, an AR device 224 may be configured to display the operational parameters of the machinery 222 using one or more anchors. In exemplary embodiments, the anchors displayed by the AR device 224 may be dynamic, i.e., the appearance of the anchors may change based on the operational parameters of the machinery 222.

In exemplary embodiments, the processor 322 of the machinery 222 is configured to monitor the location and orientation of the machinery 222 and to transmit a notification of any detected change in the location or orientation of the machinery 222 to the industrial augmented reality system 210. Responsively, the industrial augmented reality system 210 is configured to update the virtual content database 214 and to utilize the augmented reality rendering engine 212 to update the augmented reality framework of the industrial environment 220.

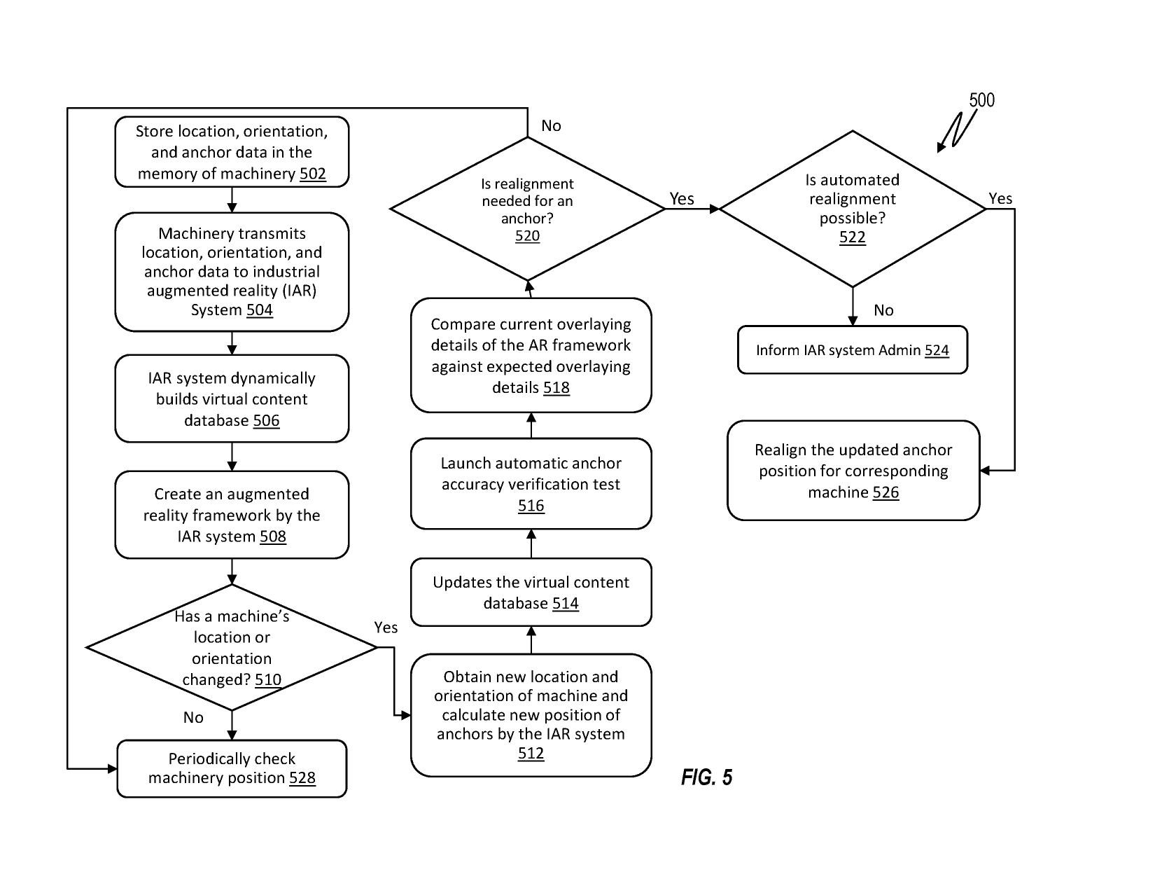

Referring now to FIG. 5, a flowchart of a method 500 managing anchors in an industrial augmented reality system in accordance with one or more embodiments of the present disclosure is shown. In exemplary embodiments, the method 500 is performed by an industrial augmented reality system 210 such as the one shown in FIG. 2.

As shown at block 502, the method 500 includes storing location, orientation, and anchor data in the memory of machinery in an industrial environment. Next, as shown at block 504, the method 500 includes the machinery transmitting the location, orientation, and anchor data to the industrial augmented reality (IAR) system. At block 506, the IAR system dynamically builds a virtual content database based on the received location, orientation, and anchor data from each of the pieces of machinery in the industrial environment. Next, as shown at block 508, the method 500 includes creating an augmented reality framework by the IAR system based on the virtual content database.

At decision block 510, the method 500 includes determining whether one or more pieces of machinery in the industrial environment have had a change to its location or orientation. Based on a determination that a piece of machinery in the industrial environment has had a change to its location or orientation, the method 500 proceeds to block 512, and an updated location and/or orientation of the machine is obtained and the new position of the anchors of the machine are calculated by the IAR system. Next, as shown at block 514, the method 500 includes updating the virtual content database with the new location and orientation of the machine and the new location of the anchors that correspond to the machine. Once the virtual database 514 has been updated, an automatic anchor accuracy verification test is triggered, as shown at block 516.

In exemplary embodiments, the automatic anchor accuracy verification test includes obtaining a first set of images, captured by an augmented reality display, of the machine and the one or more anchors in the industrial environment prior to receiving the indication that one or more of the position of the machine in the industrial environment and the orientation of the machine has changed. The automatic anchor accuracy verification test includes obtaining a second set of images, captured by the augmented reality display, of the machine and the one or more anchors in the industrial environment after receiving the indication that one or more of the positions of the machine in the industrial environment and the orientation of the machine has changed. The automatic anchor accuracy verification test includes further includes comparing the first set of images to the second set of images, calculating, based on the comparison, an adjustment in the position of one or more of the one or more anchors, and updating, the augmented reality framework for the industrial environment, based on the adjustment.

Continuing with reference to FIG. 5, at block 518 the method 500 includes comparing current overlaying details of the AR framework against expected overlaying details. For example, the location of one or more anchors relative to portions of a machine may be compared to determine whether the position of the anchors is proper. Next, as shown at decision block 520, method 500 includes determining whether realignment is needed for an anchor in the AR framework. Based on a determination that realignment is needed for an anchor in the AR framework, the method proceeds to decision block 522 and determines whether automated realignment is possible. In one embodiment, the determination of whether automated realignment is possible is based on whether a difference between the position of the anchor in the AR framework is greater than a threshold amount. For example, the distance between the location of an anchor in the AR framework from an expected location of the anchor in the AR framework is greater than a specified distance. In exemplary embodiments, the expected location of the anchor in the AR framework is based on a set of images of the AR framework that were collected before the detection of a movement of the machinery in the industrial environment. Based on a determination that an automated realignment is not possible, the method 500 proceeds to block 524 and informs the administrator of the industrial augmented reality system of the need for manual realignment. Otherwise, the method 500 proceeds to block 526 and realigns the updated anchor position for the corresponding machine in the AR framework.

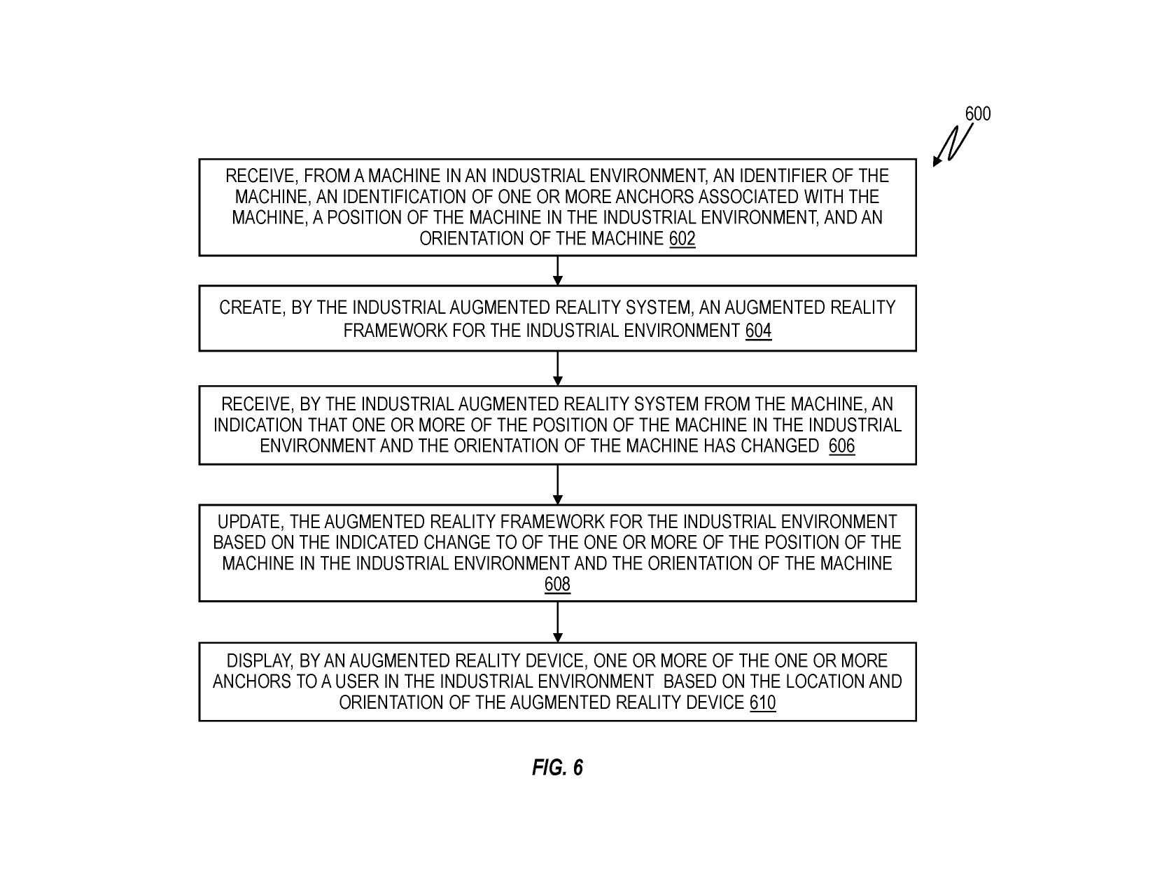

Referring now to FIG. 6, a flowchart of a method 600 for managing anchors in an industrial augmented reality system in accordance with one or more embodiments of the present disclosure is shown. In exemplary embodiments, the method 600 is performed by an industrial augmented reality system 210 such as the one shown in FIG. 2. As shown at block 602, the method 600 includes receiving, from a machine in an industrial environment, an identifier of the machine, an identification of one or more anchors associated with the machine, a position of the machine in the industrial environment, and an orientation of the machine. In exemplary embodiments, one or more of the position of the machine in the industrial environment and the orientation of the machine are determined by the machine based on an indoor positioning system disposed in the industrial environment. In exemplary embodiments, the identification of one or more anchors associated with the machine also includes a relative location of the one or more anchors relative to the position of the machine. Next, as shown at block 604, the method 600 includes creating, by the industrial augmented reality system, an augmented reality framework for the industrial environment. In exemplary embodiments, the augmented reality framework includes a location of the one or more anchors associated with the machine in the industrial environment.

As shown at block 606, the method 600 includes receiving, by the industrial augmented reality system from the machine, an indication that one or more of the position of the machine in the industrial environment and the orientation of the machine has changed. In exemplary embodiments, the indication that one or more of the position of the machine in the industrial environment and the orientation of the machine has changed is created by the machine based on the machine detecting a change in the one or more of the position of the machine in the industrial environment and the orientation of the machine.

As shown at block 608, the method 600 includes updating, the augmented reality framework for the industrial environment based on the indicated change to the one or more of the position of the machine in the industrial environment and the orientation of the machine. Next, as shown at block 610, the method 600 includes displaying, by an augmented reality device in the industrial environment, one or more of the one or more anchors to a user based on the location and orientation of the augmented reality device.

In exemplary embodiments, the method for managing anchors in an industrial augmented reality system also includes performing an automated anchor accuracy verification test. The automated anchor accuracy verification test includes obtaining a first set of images, captured by an augmented reality display, of the machine and the one or more anchors in the industrial environment prior to receiving the indication that one or more of the position of the machine in the industrial environment and the orientation of the machine has changed. The automated anchor accuracy verification test also includes receiving a second set of images, captured by the augmented reality display, of the machine and the one or more anchors in the industrial environment after receiving the indication that one or more of the position of the machine in the industrial environment and the orientation of the machine has changed. The automated anchor accuracy verification test further includes comparing the first set of images to the second set of images, calculating, based on the comparison, an adjustment in a position of one or more of the one or more anchors, and updating, the augmented reality framework for the industrial environment, based on the adjustment.

For indoor positioning systems (IPS) in an industrial floor, an Adaptive fingerprint technique that creates a "fingerprint" of the industrial floor based on signal strengths from technologies like Wi-Fi or Bluetooth at known locations. This fingerprint serves as a reference for locating objects within the space. The system continuously monitors signal strengths from Wi-Fi/Bluetooth in the environment and detects significant changes from stored fingerprint.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for managing anchors in an industrial augmented reality system, the computer-implemented method comprising:
receiving, from a machine in an industrial environment, an identifier of the machine, an identification of one or more anchors associated with the machine, a position of the machine in the industrial environment, and an orientation of the machine;
creating, by the industrial augmented reality system, a augmented reality framework for the industrial environment, wherein the augmented reality framework includes a location of the one or more anchors associated with the machine in the industrial environment;
receiving, by the industrial augmented reality system from the machine, an indication that one or more of the position of the machine in the industrial environment and the orientation of the machine has changed; and
updating, the augmented reality framework for the industrial environment based on the indicated change to of the one or more of the position of the machine in the industrial environment and the orientation of the machine.

2. The computer-implemented method of claim 1, wherein the indication that one or more of the position of the machine in the industrial environment and the orientation of the machine has changed is created by the machine based on the machine detecting a change in the one or more of the position of the machine in the industrial environment and the orientation of the machine.

3. The computer-implemented method of claim 1, wherein one or more of the position of the machine in the industrial environment and the orientation of the machine are determined by the machine based on an indoor positioning system disposed in the industrial environment.

4. The computer-implemented method of claim 1, wherein the identification of one or more anchors associated with the machine also includes a relative location of the one or more anchors relative to the position of the machine.

5. The computer-implemented method of claim 1, further comprising receiving a first set of images, captured by an augmented reality display, of the machine and the one or more anchors in the industrial environment prior to receiving the indication that one or more of the position of the machine in the industrial environment and the orientation of the machine has changed.

6. The computer-implemented method of claim 5, further comprising receiving a second set of images, captured by the augmented reality display, of the machine and the one or more anchors in the industrial environment after receiving the indication that one or more of the position of the machine in the industrial environment and the orientation of the machine has changed.

7. The computer-implemented method of claim 6, further comprising:
comparing the first set of images to the second set of images;
calculating, based on the comparison, an adjustment in a position of one or more of the one or more anchors; and
updating, the augmented reality framework for the industrial environment, based on the adjustment.

8. The computer-implemented method of claim 1, further comprising displaying, by an augmented reality device in the industrial environment, one or more of the one or more anchors to a user based on the location and orientation of the augmented reality device.

9. A computing system having a memory having computer readable instructions and one or more processors for executing the computer readable instructions, the computer readable instructions controlling the one or more processors to perform operations comprising:
receiving, from a machine in an industrial environment, an identifier of the machine, an identification of one or more anchors associated with the machine, a position of the machine in the industrial environment, and an orientation of the machine;
creating, by a industrial augmented reality system, a augmented reality framework for the industrial environment, wherein the augmented reality framework includes a location of the one or more anchors associated with the machine in the industrial environment;
receiving, by the industrial augmented reality system from the machine, an indication that one or more of the position of the machine in the industrial environment and the orientation of the machine has changed; and
updating, the augmented reality framework for the industrial environment based on the indicated change to of the one or more of the position of the machine in the industrial environment and the orientation of the machine.

10. The computing system of claim 9, wherein the indication that one or more of the position of the machine in the industrial environment and the orientation of the machine has changed is created by the machine based on the machine detecting a change in the one or more of the position of the machine in the industrial environment and the orientation of the machine.

11. The computing system of claim 9, wherein one or more of the position of the machine in the industrial environment and the orientation of the machine are determined by the machine based on an indoor positioning system disposed in the industrial environment.

12. The computing system of claim 9, wherein the identification of one or more anchors associated with the machine also includes a relative location of the one or more anchors relative to the position of the machine.

13. The computing system of claim 9, wherein the operations further comprise receiving a first set of images, captured by an augmented reality display, of the machine and the one or more anchors in the industrial environment prior to receiving the indication that one or more of the position of the machine in the industrial environment and the orientation of the machine has changed.

14. The computing system of claim 13, wherein the operations further comprise receiving a second set of images, captured by the augmented reality display, of the machine and the one or more anchors in the industrial environment after receiving the indication that one or more of the position of the machine in the industrial environment and the orientation of the machine has changed.

15. The computing system of claim 14, wherein the operations further comprise:
comparing the first set of images to the second set of images;
calculating, based on the comparison, an adjustment in a position of one or more of the one or more anchors; and
updating, the augmented reality framework for the industrial environment, based on the adjustment.

16. The computing system of claim 9, wherein the operations further comprise displaying, by an augmented reality device in the industrial environment, one or more of the one or more anchors to a user based on the location and orientation of the augmented reality device.

17. A computer program product comprising a computer readable storage medium having program instructions embodied therewith, the program instructions executable by a processor to cause the processor to perform operations comprising:
receiving, from a machine in an industrial environment, an identifier of the machine, an identification of one or more anchors associated with the machine, a position of the machine in the industrial environment, and an orientation of the machine;
creating, by a industrial augmented reality system, a augmented reality framework for the industrial environment, wherein the augmented reality framework includes a location of the one or more anchors associated with the machine in the industrial environment;
receiving, by the industrial augmented reality system from the machine, an indication that one or more of the position of the machine in the industrial environment and the orientation of the machine has changed; and
updating, the augmented reality framework for the industrial environment based on the indicated change to of the one or more of the position of the machine in the industrial environment and the orientation of the machine.

18. The computer program product of claim 17, wherein the indication that one or more of the position of the machine in the industrial environment and the orientation of the machine has changed is created by the machine based on the machine detecting a change in the one or more of the position of the machine in the industrial environment and the orientation of the machine.

19. The computer program product of claim 17, wherein one or more of the position of the machine in the industrial environment and the orientation of the machine are determined by the machine based on an indoor positioning system disposed in the industrial environment.

20. The computer program product of claim 17, wherein the identification of one or more anchors associated with the machine also includes a relative location of the one or more anchors relative to the position of the machine.
